(19) United States
(12) Patent Application Publication
(10) Pub. No.: US 2006/0118624 A1
(43) Pub. Date: Jun. 8, 2006

(54) Systems and methods for preventing use of card skimmers on electronic card terminals

(75) Inventors: Scott Edwards Kelso, Durham, NC (US); John Carl Mese, Cary, NC (US); Nathan J. Peterson, Raleigh, NC (US); Rod David Waltermann, Durham, NC (US); Arnold S. Weksler, Raleigh, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 11/005,240

(22) Filed: Dec. 6, 2004

(51) Int. Cl. G06K 7/04; G06K 7/00

(52) U.S. Cl. 235/444; 235/439

(57) ABSTRACT

Systems and methods for preventing the use of card skimmers on electronic card terminals are disclosed. Embodiments include a method that generally includes ejecting from a card slot in a rear faceplate an electronic card and determining the relative movement between a front faceplate and the card slot. Embodiments also include before receiving a second electronic card, changing the relative position of the card slot and the front faceplate. Embodiments may include moving the rear faceplate or moving the front faceplate. Further embodiments may include detecting an error during the changing of the relative position of the card slot and the front faceplate and, if an error is detected, moving the card slot to a lockdown position. Movements between the front faceplate and the card slot may be vertical, horizontal, radial, etc., and may be randomly generated.

### FIELD OF INVENTION

The present invention is in the field of electric card terminals. More particularly, the present invention relates to systems and methods for preventing the use of card skimmers on electronic card terminals.

### BACKGROUND

Electronic card terminals, such as Automated Teller Machines (ATMs), are well known in the art. Using an electronic card terminal, a customer can quickly access a bank or other account using an electronic card such as a bank ATM card. Electronic cards typically have a magnetic stripe that, when ‘swiped’ in the electronic card terminal, allows the electronic card terminal to read information contained in the magnetic stripe. The magnetic stripe may contain account numbers and the name of the customer. Often, to help prevent fraud in the event that an electronic card is used by someone other than the customer, the electronic card terminal requires the customer to enter a Personal Identification Code (PIN) code as additional authorization for her to access the account. Once the customer has been authorized, she may access her account and perform tasks such as withdrawing cash, viewing account balances, and transferring money.

Because of their convenience and utility, electronic cards (and electronic card terminals) have become ubiquitous tools for accessing accounts. Bank customers have embraced electronic cards because of their small size and convenience, which allows them to access their accounts and withdraw cash from almost anywhere in the world. Banks and other financial institutions have encouraged use of electronic cards as they, in addition to providing convenience to customers, allow banks to reduce bank hours, the number of tellers, and the like, reducing costs and improving efficiency for the bank.

The widespread use of electronic cards for banking and other financial transactions have made them a tempting target for thieves. Theft of the electronic card or the encoded data from the electronic card are both common. Thieves use many different methods to try to steal money, electronic cards, or data from electronic card terminals, such as brute force, fake electronic card terminals, or card trapping devices. One method of capturing a customer's account information from the electronic card is to use a skimmer or skimming device. Skimmers are devices used to capture the data stored on the magnetic strip of the electronic card by placing a small card reader on top of, or in close proximity to, the actual card reader input slot. A customer who does not notice the skimmer will allow their electronic card to be swiped both by the skimmer and the actual card reader and will not necessarily realize that her information has been stolen, as she will have completed her transaction normally. Thieves often design the skimmers to appear as part of the electronic card terminal so that customers do not become suspicious and so that the amount of account information stolen can therefore be maximized.

Once the information is obtained, the thief would then re-encode another electronic card with that information, transforming a blank card into a machine-readable electronic card. Equipped with a PIN code, a thief may then use the new electronic card to illegally extract money from electronic card terminals. Skimmers are often also combined with video cameras located nearby so that a customer's PIN code may also be stolen allowing easy access to the customer's account. Other techniques for stealing PIN codes also exist.

Electronic card terminal operators have devised a number of solutions to the problem of skimming, but all are plagued by ineffectiveness or excessive cost. One common solution is to rely on customers, bank personnel, or service technicians to notice that a skimmer has been placed on an electronic card terminal. Such a solution, however, may result in a skimmer collecting information on many electronic cards before the existence of the skimmer is detected.

Another solution to skimming is intentionally causing erratic movement of the electronic card during card insertion and return. Erratic movement may include changing the speed of insertion or return or even changing the direction of movement of the electronic card itself. Some skimming devices rely on a consistent swipe of the electronic card in order to read information from the magnetic stripe. The erratic movement may, in some cases, make it impossible for the card information to be read accurately by a skimmer. Many skimming devices are capable of reading the electronic card in spite of the “jitter” of the card as it enters or leaves the card slot as the creators of the skimming device are able to adapt their design, making this solution inadequate in many circumstances.

Another solution to skimming is to monitor transactions on accounts to look for suspicious activity, such as unusually frequent or large withdrawals on an individual's account. When unusual activity is detected, the electronic card may be deactivated until the proper owner is contacted and their usage confirmed. This method will only catch thieves in some cases and is likely to create a number of false alarms, wasting resources and possibly annoying customers. Even when a skimming thief is detected and the electronic card deactivated, some money is likely to have been withdrawn before the unusual activity was detected.

ATM operators have also developed a solution to combat skimming that attempts to detect skimmers using sensors. One solution utilizes an array of light sources and photosensors positioned across the face of the card reader in a “light curtain” style of arrangement, similar to the source-sensor pair used to prevent most modern garage doors from coming down on something. If a skimmer attached to the front of the ATM blocked the light an alarm would be triggered and the ATM shut down. This approach, however, is often plagued by false alarms caused by environmental circumstances (false alarms caused by the setting sun, car headlights at night, etc.) or caused by customer actions like fiddling with their wallet and blocking the light path when pulling out their electronic card.

There is, therefore, a need for an effective system to deter or prevent the use of card skimmers on electronic card terminals. There is an even greater need for such a system that does not require customer activity or knowledge.

### SUMMARY OF THE INVENTION

The problems identified above are in large part addressed by systems and methods for preventing the use of card skimmers on an electronic terminal. One embodiment provides an electronic card terminal that may include a card reader for reading information stored on an electronic card and a rear faceplate with a card slot, where the card slot facilitates movement of the electronic card to and from the card reader. The electronic card terminal may also provide a front faceplate positioned to at least partially cover the rear faceplate, where the front faceplate has an access hole, and a card slot driver for changing the relative positions of the front faceplate and the card slot. The card slot driver may change the relative positions of the front faceplate and the card slot such that the card slot is completely underneath the front faceplate or partially underneath the front faceplate. The card slot driver may change the relative position of the front faceplate and the card slot by moving the rear faceplate or moving the front faceplate in some embodiments.

A further embodiment provides a method for preventing the use of card skimmers on an electronic card terminal. The method may generally include ejecting from a card slot in a rear faceplate an electronic card and determining relative movement between a front faceplate and the card slot. The method may also generally include, before receiving a second electronic card, changing the relative position of the card slot and the front faceplate. Further embodiments may including detecting an error during the changing of the relative position of the card slot and the front faceplate and, in the event an error is detected, moving the card slot to a lockdown position.

A further embodiment provides an electronic card terminal that includes a rear faceplate having a card slot and a front faceplate having an access hole. The electronic card terminal may also include one or more motorized rollers for pulling an electronic card inserted into the card slot toward a card reader and for ejecting the electronic card from the card slot. The electronic card terminal may also include an exit catch bin positioned between the rear faceplate and the front faceplate for catching an electronic card being ejected from the card slot. In additional embodiments, the motorized rollers eject the electronic card towards the rear faceplate, where the rear faceplate is at least partially curved.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a front schematic view of an electronic card terminal with a front faceplate and a rear faceplate according to one embodiment;

FIG. 2 depicts a side schematic view of the electronic card terminal of FIG. 1 with drive assemblies according to one embodiment;

FIG. 3 depicts a side schematic view of the electronic card terminal of FIG. 1 with a card reader mount according to one embodiment;

FIG. 4 depicts a side schematic view of the electronic card terminal of FIG. 1 with a curved rear faceplate according to one embodiment;

FIG. 5 depicts a side schematic view of the electronic card terminal of FIG. 1 according to an alternative embodiment; and

FIG. 6 depicts an example of a flow chart for an electronic card system to prevent the use of card skimmers according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Various embodiments of the present invention provide systems for preventing the use of card skimmers on electronic card terminals. The following description provides specific details of certain embodiments of the invention illustrated in the drawings to provide a thorough understanding of those embodiments. It should be recognized, however, that the present invention can be reflected in additional embodiments and may be practiced without some of the details in the following description. In other instances, well-known structures and functions have not been shown or described in detail to avoid unnecessarily obscuring the description of the embodiments of the invention. While specific embodiments will be described below with reference to particular configurations and systems, those of skill in the art will realize that embodiments of the present invention may advantageously be implemented with other substantially equivalent configurations and/or systems.

Systems and methods for preventing the use of card skimmers on electronic card terminals are disclosed. Embodiments include a method that generally includes ejecting from a card slot in a rear faceplate an electronic card and determining the relative movement between a front faceplate and the card slot. Embodiments also include before receiving a second electronic card, changing the relative position of the card slot and the front faceplate. Embodiments may include moving the rear faceplate or moving the front faceplate. Further embodiments may include detecting an error during the changing of the relative position of the card slot and the front faceplate and, if an error is detected, moving the card slot to a lockdown position. Movements between the front faceplate and the card slot may be vertical, horizontal, radial, etc., and may be randomly generated.

The disclosed embodiments provide an effective system for preventing the use of card skimmers on an electronic card terminal by making it difficult to securely attach a card skimmer to the electronic card terminal. By positioning the card slot on the rear faceplate that is located under a front faceplate, the card slot may be moved relative to the front faceplate, making it more difficult for card skimmers to remain attached. A card skimmer attached to the rear faceplate and over the card slot may strike the front faceplate when the card slot moves toward or under the front faceplate, possibly dislodging the card skimmer. A card skimmer attached to the front faceplate faces other difficulties, as the final position of the card slot relative to the front faceplate may be changed between customers, making it very difficult to design an effective card skimmer. Accordingly, the electronic card terminal of the disclosed embodiments provides an effective system for preventing or deterring the use of card skimmers by changing the position of the card slot.

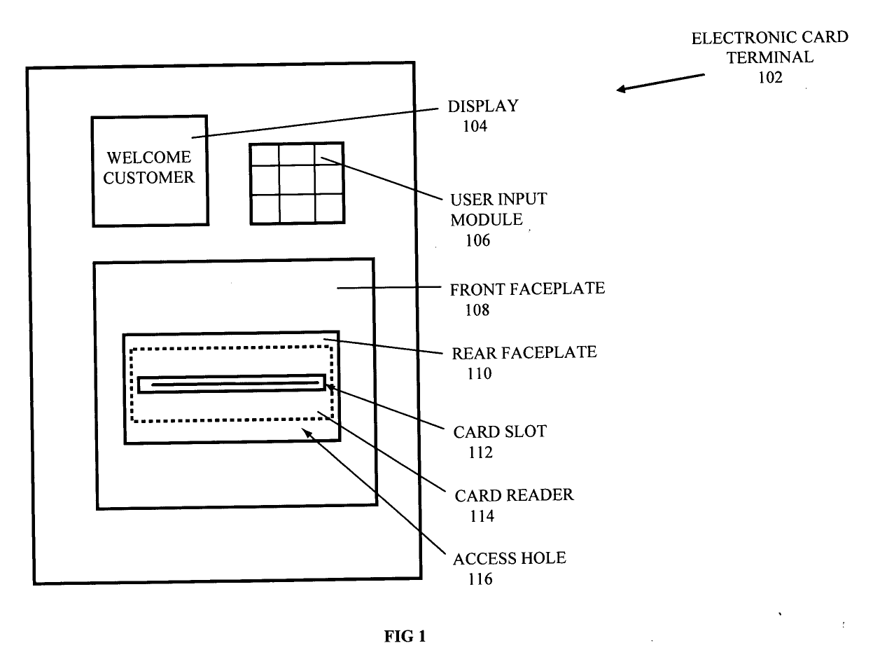

Turning now to the drawings, FIG. 1 depicts a front schematic view of an electronic card terminal with a front faceplate and a rear faceplate according to one embodiment. In the depicted embodiment, the electronic card terminal 102 includes a display 104, a user input module 106, a front faceplate 108, a rear faceplate 110, a card slot 112, and a card reader 114. Electronic card terminals 102 may include any device adapted to read an electronic card, such as ATMs, point-of-service (POS) terminals, Electronic Financial Transaction (EFT) terminals, credit card terminals, pay stations, or the like. Electronic cards may include bank cards, credit cards, EFT cards, debit cards, pre-paid purchase cards, loyalty cards, identification cards, and the like.

The card slot 112 and card reader 114 are known in the art. The cart slot 112 may include a slot adapted to allow passage of an electronic card to a card reader 114 and may also optionally include a drive mechanism, such as motorized rollers, to move the electronic card through the card slot 112. The card reader 114 may be any device adapted to read information from an electronic card, such as magnetic stripe reader. In one embodiment, card slot 112 is located in the rear faceplate 110 and the card reader 114 is located behind the rear faceplate 110 and within the electronic card terminal 102. Other designs and configurations of the card slot 112 and/or card reader 114 are possible.

A customer of an electronic card terminal 102 with an electronic card may insert the card into the card slot 112, allowing the card reader 114 to read the electronic card. The customer may then use the display 104 and/or user input module 106 to perform various tasks, such as for purchasing items or withdrawing, depositing, or transferring money. A thief desiring to use a card skimmer to capture information from a customer's electronic card would typically place the card skimmer over the card slot 112. The card skimmer would in this case have a card slot and card reader of its own positioned over the card slot 112 of the electronic card terminal 102 so that a customer would have to move their electronic card through the card skimmer in order to insert their electronic card into card slot 112. This allows the card reader of the card skimmer to read the information stored on the electronic card while still allowing the electronic card to enter the card slot 112, so that the customer may not notice anything unusual (as they will still be able to perform their desired tasks). A thief would typically attach the card skimmer to the faceplate of an electronic card terminal 102 in order to properly position the card skimmer and align its card slot and/or card reader with the card slot 112 of the electronic card terminal 102. For the electronic card terminal 102 of the disclosed embodiments, a card skimmer would likely be attached to a recessed rear faceplate 110.

The electronic card terminal 102 of the disclosed embodiments increases the difficulty of successfully attaching a card skimmer to the electronic card terminal 102 and maintaining that attachment. In between interactions with customers, the electronic card terminal 102 may change the position of the card slot 112 relative to the front faceplate 108 (by either moving the rear faceplate 110 or the front faceplate 108) so that any attached card skimmers are forcibly detached from the rear faceplate 110. By moving the card slot 112 close to (or under) the front faceplate 108, an attached card skimmer positioned over the card slot 112 will strike the front faceplate 108 and potentially be dislodged or removed. If a card skimmer is removed, it will no longer be able to read electronic cards of other customers. If a card skimmer is slightly dislodged, its card slot will likely no longer line up with card slot 112, allowing customers to potentially notice the abnormal configuration. This provides an effective mechanism for preventing the use of card skimmers on the electronic card terminal 102 of the disclosed embodiments.

A customer or other use may receive information from the electronic card terminal 102 via the display 104. Display 104 may be a video monitor, printer, auditory device, or the like. For example, a customer may view account information, such as transaction records or balances, on the display 104. A customer may input information, such as PIN codes, passwords, or instructions, via user input module 106. In one embodiment, user input module 106 is a keypad adapted to accept user input via a plurality of buttons. In an alternative embodiment, the display 104 and user input module 106 may be combined into one device, such as a touch-screen that both displays information and accepts input.

The front faceplate 108 may be of any size or shape, such as a substantially flat surface or a curved surface. The front faceplate 108 may have an access hole 116 that provides customer access to a rear faceplate 110 located behind the front faceplate 108. The customer access of the rear faceplate 110 through the access hole 116 in the front faceplate 108 facilitates access by the customer of the card slot 112 so that the customer may insert electronic cards into the card slot 112. The access hole 116 in the front faceplate 108 may be any size and any shape that may be suitable to allow the insertion of an electronic card into the card slot 112 when the relative positions of the front faceplate 108 and rear faceplate 110 allow such access to the card slot 112.

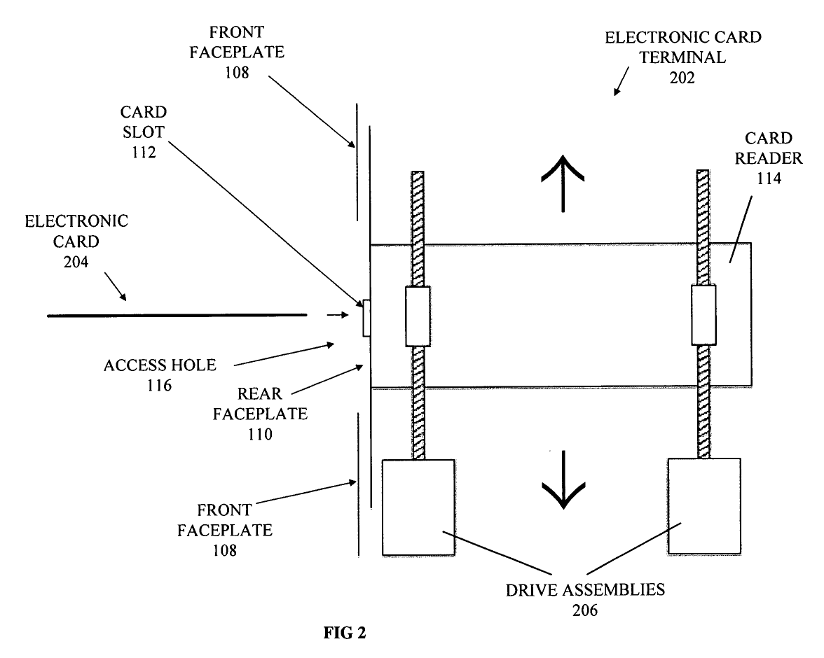

The rear faceplate 110 may also be of any size or shape suitable for including a card slot 112. The rear faceplate 110 may be positioned behind the front faceplate 108 (relative to where a customer would access the electronic card terminal 102). The rear faceplate 110 and front faceplate 108 may move in relation to each other, which may be accomplished by moving the rear faceplate 110, the front faceplate 108, or a combination of both. A card slot driver, as described in relation to FIGS. 2-4, may be used to move the front faceplate 108 and/or the rear faceplate 110 and thus change the relative position of the front faceplate 108 and the card slot 112. The card slot driver, in one embodiment, moves the front faceplate 108 and/or the rear faceplate 110 so that the card slot 112 approaches or passes under the access hole 116 of the front faceplate 108. The card slot driver may move the front faceplate 108 and/or the rear faceplate 110 in a pre-determined pattern, randomly, based on various criteria, or in any other fashion. In one embodiment, the card slot driver moves the front faceplate 108 and/or the rear faceplate 110 so that the card slot 112 approaches or goes underneath each edge of the access hole 116 (and the edge of the front faceplate 108) so as to maximize the probability that a card skimmer attached at any point on the rear faceplate 110 is detached.

One optional embodiment provides additionally for completing the movement of the front faceplate 108 and/or the rear faceplate 110 so that the card slot 112 ends in a different position relative to the front faceplate 108 than where it started. By moving the final position of the card slot 112 for each customer, thieves will be prevented from successfully placing a card skimmer on the front faceplate 108, as the thieves will be unable to predict the final location of the card slot 112. For example, if the card skimmer is aligned so that it works when the card slot 112 is in one position, it will likely not work when the card slot 112 is in a different position a few inches away. This embodiment provides additional security over moving the card slot 112 in between customers to attempt to detach card skimmers located on the rear faceplate 110, as card skimmers located on the front faceplate 108 are also prevented or deterred.

Another optional embodiment includes a “lock down” or safety position for the card slot 112 where customers (or thieves) cannot access the card slot 112 at all. In this embodiment, the card slot driver may move the front faceplate 108 and/or the rear faceplate 110 so that the card slot 112 is at least partially blocked by the front faceplate 108. This prevents anyone from inserting electronic cards into card slot 112. This mode may be triggered by, for example, detection of a blockage of the movement of the front faceplate 108 and/or the rear faceplate 110 that indicates the existence of a card skimmer that is not detached by movement caused by the card slot driver. This embodiment provides an additional level of security for situations where card skimmers attached to the rear faceplate 110 cannot easily be removed.

An alternative embodiment provides for changing the relative position of the front faceplate 108 and the card slot 112 by changing the physical configuration of the front faceplate 108. In this embodiment, the physical configuration of the front faceplate 108 may be changed so that the front faceplate 108 at least partially covers the card slot 112. For example, the front faceplate 108 may include a door, panel or other portion that slides or moves over the card slot 112, such as upon the actuation of a button. The door may be able to dislodge a card skimmer while it passes over or near the card slot 112.

FIG. 2 depicts a side schematic view of the electronic card terminal of FIG. 1 with drive assemblies according to one embodiment. The electronic card terminal 202 of FIG. 2 includes many components described in relation to the electronic card terminal 102 of FIG. 1 and the descriptions will not be repeated in the interest of brevity. In the depicted embodiment, an electronic card 204 may be inserted by a customer into the card slot 112 of the electronic card terminal 202. The electronic card 204 may only be inserted when the access hole 116 of the front faceplate 108 is over the card slot 112, allowing access to the card slot 112 by the customer. The rear faceplate 110 may move relative to the front faceplate 108, changing the position of the card slot 112 in relation to the front faceplate 108.

In the embodiment of FIG. 2, one or more drive assemblies 206 may serve as the card slot driver. The drive assemblies 206 of the depicted embodiment may move the card reader 114 vertically (perpendicular to the ground) in a direction substantially parallel to the front faceplate 108 and the rear faceplate 110. The card reader 114 of the depicted embodiment is attached to the rear faceplate 110, such that the rear faceplate 110 moves with the card reader 114 when driven by the drive assemblies 206. As the card slot 112 is located on the rear faceplate 110, the drive assemblies 206 will effectively serve to move the card slot 112 up and down. When the card slot 112 is moved close to the edge of the front faceplate 108 (also the edge of the access hole 116), an attached card skimmer may be scraped off or dislodged. The card slot 112 may optionally be moved all the way under the front faceplate 108 to increase the likelihood of removal of any card skimmers. The drive assemblies 206 may use any type of pattern of movement. For example, the drive assemblies 206 may move the card slot 112 both up and down to the edge of the front faceplate 108 after a transaction with each customer is completed. In another example, the driver assemblies 206 move the card slot 112 in a random pattern to make it more difficult for card skimmers to be designed to adapt to the movement.

In an alternative embodiment, the drive assemblies 206 may move the card reader 114 (and card slot 112) in a different direction than vertical. For example, the drive assemblies 206 may be positioned to move the card reader 114 horizontally (parallel to the ground), resulting in the card slot 112 moving towards the left and right when a customer faces the electronic card terminal 202. In other examples, the drive assemblies 206 may be positioned to move the card reader 114 in a different direction or combination of directions, such as diagonally or in a random pattern.

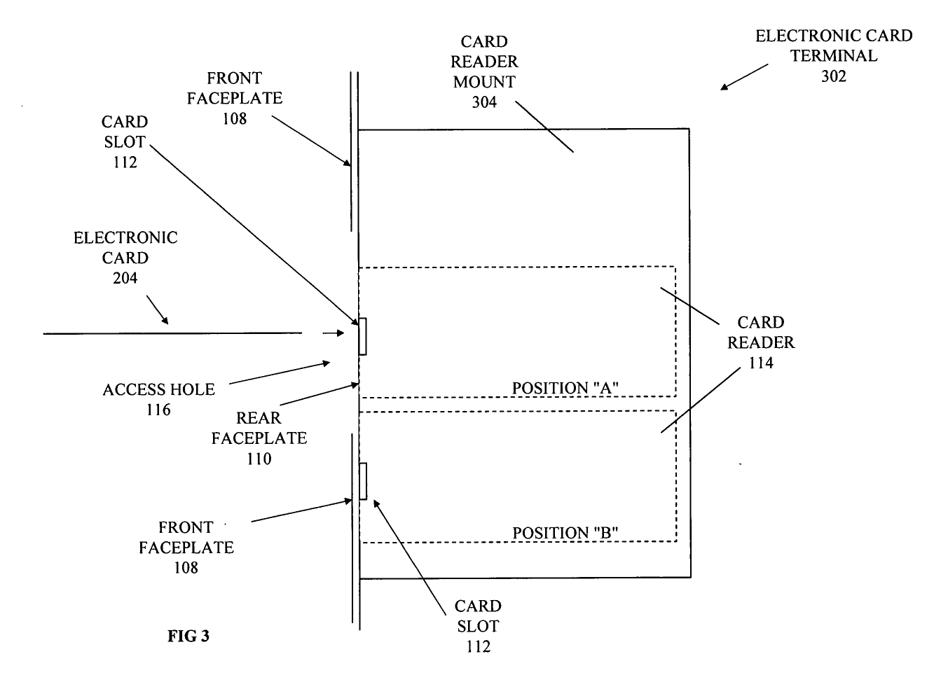

FIG. 3 depicts a side schematic view of the electronic card terminal of FIG. 1 with a card reader mount according to one embodiment. The electronic card terminal 302 of FIG. 3 includes many components described in relation to the electronic card terminals 102, 202 of FIGS. 1 and 2, respectively, and the descriptions will not be repeated in the interest of brevity. In the depicted embodiment, an electronic card 204 may be inserted by a customer into the card slot 112 of the electronic card terminal 302. The electronic card 204 may only be inserted when the access hole 116 of the front faceplate 108 is over the card slot 112, allowing access to the card slot 112 by the customer. The rear faceplate 110 may move relative to the front faceplate 108, changing the position of the card slot 112 in relation to the front faceplate 108.

In the depicted embodiment, the electronic card terminal 302 includes a card reader mount 304 which serves as the card slot driver. The card reader mount 304 may attach the card reader 114 to the electronic card terminal 302 and change the position of the card reader 114. The rear faceplate 110 may be attached to the card reader 114 so that movement of the card reader 114 caused by the card reader mount 304 also moves the rear faceplate 110 (and card slot 112). The card reader mount 304 may use any mechanism or methodology for changing the position of the card reader 114, such as using hydraulics or electrically-powered motors. The card reader mount 304 may facilitate movement of the card reader 114 in any direction or combination of directions, including in any direction in a plane parallel with the front faceplate 108.

In FIG. 3, two different locations of the card reader 114 (and thus card slot 112 and rear faceplate 110) are depicted. At position “A”, the card reader 114 is positioned by the card reader mount 304 so that the card slot 112 is located in the access hole 116 of the front faceplate 108. When the card slot 112 is in this location, a customer may access the card slot 112 and insert or remove electronic cards 204. If a thief places a card skimmer over the card slot 112 while it is in this location, the thief is likely to be successful if the card slot 112 does not move. The card reader mount 304 may move the card reader 114 (and card slot 112) to a position that results in the dislodging or attachment of a card skimmer, such as position “B”. In position “B”, the card slot 112 is underneath the front faceplate 108 which precludes the presence of foreign objects such as card skimmers over the card slot 112. The movement from position “A” to “B” is likely to dislodge or remove any attached card skimmers. Positions “A” and “B” are only two examples of positions of the card reader 114 and card slot 112 and any other suitable position is possible.

In an alternative embodiment, the card reader 114 may be rotatably mounted to or within the card reader mount 304. In this embodiment, the card reader mount 304 may rotate the card reader 114 instead of moving it horizontally or vertically. The card reader mount 304 may rotate the card reader 114 far enough so that any attached card skimmer is detached by the front faceplate 108. This embodiment may be particularly useful where the access hole 116 of the front faceplate 108 is only slightly larger than the card slot 112 as rotation of the card reader 114 (and thus the card slot 112) will bring part of the card slot 112 under the front faceplate 108. This embodiment may also be combined with others to increase the chance that a card skimmer will be detached. For example, thieves will find it more difficult to design a card skimmer that can survive horizontal, vertical, and rotational movement of the card slot 112 than designing a card skimmer that need only survive one.

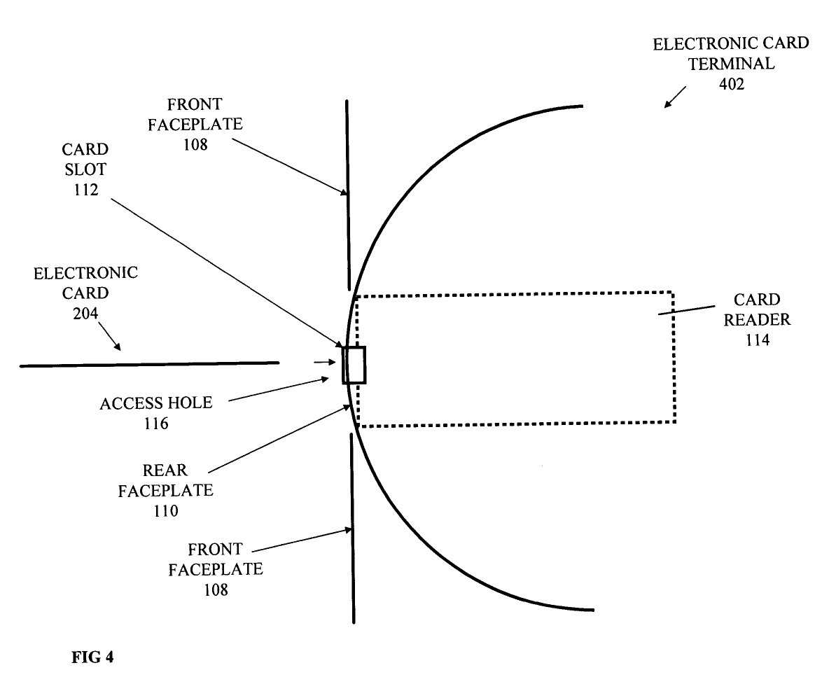

FIG. 4 depicts a side schematic view of the electronic card terminal of FIG. 1 with a curved rear faceplate according to one embodiment. The electronic card terminal 402 of FIG. 4 includes many components described in relation to the electronic card terminals 102, 202, 302 of FIGS. 1, 2, 3, respectively, and the descriptions will not be repeated in the interest of brevity. In the depicted embodiment, an electronic card 204 may be inserted by a customer into the card slot 112 of the electronic card terminal 402. The electronic card 204 may only be inserted when the access hole 116 of the front faceplate 108 is over the card slot 112, allowing access to the card slot 112 by the customer. The rear faceplate 110 may move relative to the front faceplate 108, changing the position of the card slot 112 in relation to the front faceplate 108.

In the depicted embodiment of FIG. 4, the rear faceplate 110 is curved or rounded, allowing the rear faceplate 110 to be pivoted about a point. When the rear faceplate 110 is pivoted, the card slot 112 will move radially about a point within the electronic card terminal 402. Any type of motor or mechanism that can pivot the rear faceplate 110 may serve as the card slot driver. The card slot driver may pivot the rear faceplate 110 by either pivoting the rear faceplate 110 itself or by rotating a card reader 114 attached to the rear faceplate 110. The rear faceplate 110 may be pivoted in any direction, including up and down far enough for the card slot 112 to reach the front faceplate 108 and optionally pass underneath the front faceplate 108. Pivoting a curved or rounded rear faceplate 110 provides an effective mechanism for moving the card slot 112 and potentially dislodging any attached card skimmers. In some embodiments, the curved or rounded rear faceplate 110 may be more effective than other embodiments as it may apply both a lateral and outward force on an attached card skimmer striking the edge of the front faceplate 108 because of the pivoting movement of the rear faceplate 110. This may be particularly effective if the front faceplate 108 is sized to be substantially close to the rear faceplate 108 so as to effectively “pry” an attached card skimmer off of the rear faceplate 110.

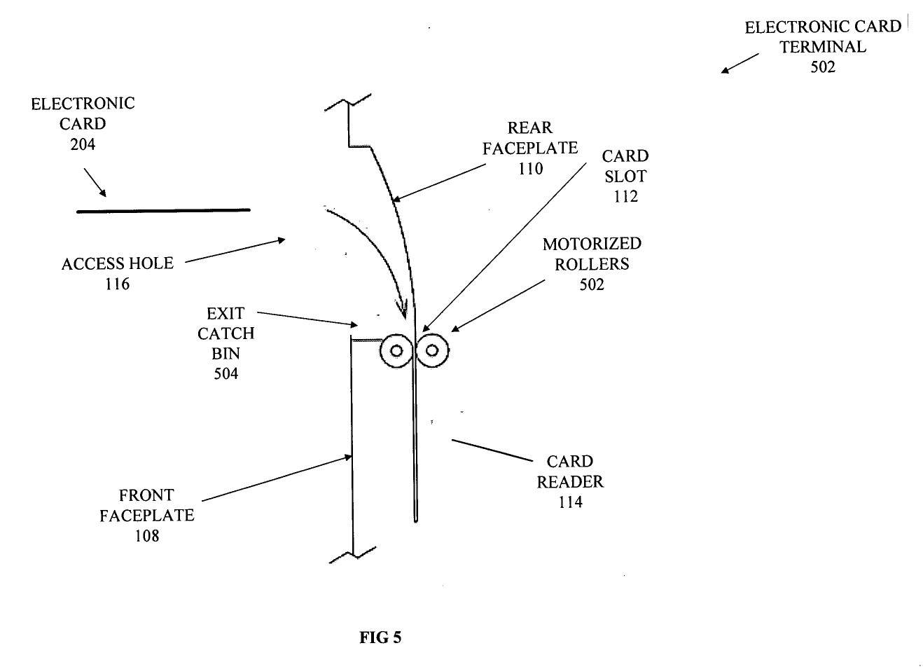

FIG. 5 depicts a side schematic view of the electronic card terminal of FIG. 1 according to an alternative embodiment. The electronic card terminal 502 of FIG. 3 includes many components described in relation to the electronic card terminals 102, 202, 302, and 402 of FIGS. 1, 2, 3 and 4, respectively, and the descriptions will not be repeated in the interest of brevity. In the depicted embodiment, an electronic card 204 may be inserted by a customer into the card slot 112 of the electronic card terminal 502. The customer may insert the electronic card 204 by holding the card between her thumb and forefinger with one of the flat faces of the electronic card 204 facing her. While holding the electronic card 204, she may move the edge of the card to the card slot 112 via the access hole 116, which may require tilting the electronic card 204 to accommodate the curved rear faceplate 110, and then insert the electronic card 204 into the card slot 112. The electronic card terminal 502 may include a front faceplate 108 and a recessed and curved rear faceplate 110 that allows access to card slot 112. The volume formed by the rear faceplate 110 and the front faceplate 108 may serve as the access hole 116, similar to an entry chute for inserting electronic cards 204.

In the embodiment of FIG. 5, the motorized rollers 502 positioned at or near the card slot 112 may serve as the card slot driver. The motorized rollers 502 may move an electronic card 204 into the electronic card terminal 502 to a card reader 114 and also may eject the electronic card 204 when the card reader 114 has finished its operation. When an electronic card 204 is ejected, it is ejected into the access hole 116. An exit catch bin 504 may prevent the electronic card 204 from falling to the ground. For example, the top of an ejected electronic card 204 may strike the portion of the rear faceplate at the top of the access hole 116, while the bottom of the electronic card 204 is prevented from passing the plane of the front faceplate 108 by the exit catch bin 504. This provides an effective mechanism for retaining control over the electronic card 204 after ejection.

When a card skimmer is attempted to be placed on the electronic card terminal 502 of FIG. 5, the design of the electronic card terminal 502 will make it evident to a customer that something is amiss. If a card skimmer is located on the front faceplate 108 (effectively covering the access hole 116), the electronic card 204 will not be returned to the customer as it will be blocked by the card skimmer, alerting the customer. Similarly, if a card skimmer is mounted directly over the card slot 112 (such as in the exit catch bin 504 or on the rear faceplate 110), the customer will notice that the electronic card 204 does not eject properly.

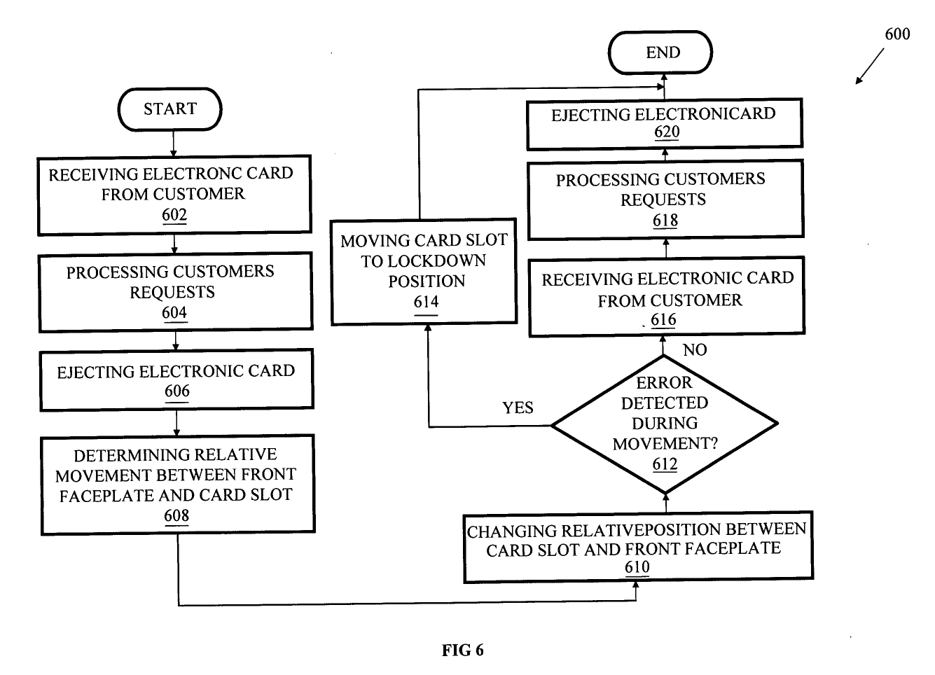

FIG. 6 depicts an example of a flow chart for an electronic card system to prevent the use of card skimmers according to one embodiment. The method of flow chart 600 may be performed, in one embodiment, by an electronic card terminal 102 such as those described in relation to FIGS. 1-5. Flow chart 600 begins with element 602, receiving an electronic card 204 from a customer. The electronic card terminal 102 may receive the electronic card 204 via a card slot 112 in one embodiment. After receiving the electronic card 204, the electronic card terminal 102 may process the customer's requests or performs other actions at element 604 based on interactions with the customer via the display 104 or user input module 106. Flow chart 600 continues to element 606 where the electronic card terminal 102 ejects the electronic card 204, such as via the card slot 112.

After processing a transaction for a customer in elements 602, 604, and 606, flow chart 600 continues to element 608, where the electronic card terminal 102 determines the relative movement between the front faceplate 108 and the card reader slot 112. The relative movement between the front faceplate 108 and the card reader slot 112 may be determined in any fashion and based on any criteria. In one example, a random pattern is used to determine the relative movement. In another example, a random pattern is used but it is ensured that the card reader slot 112 goes to within a certain distance (or underneath) the front faceplate 108 in a number of directions. In another example, a pre-programmed path for the card reader slot 112 may be used that is optimized for removing any attached card skimmers. After a movement path is determined, flow chart 600 continues to element 614, changing the relative position between the card slot 112 and the front faceplate 108. This may be accomplished in any way, such as by moving the rear faceplate 110, by moving the front faceplate 108, or a combination of the two. In one example, the rear faceplate 110 may be moved, which will also move the card slot 112. In another embodiment, a card reader 114 may be moved, which will result in movement of both the card slot 112 and rear faceplate 110.

After determining the relative movement at element 608, the electronic card terminal 102 will attempt to change the relative position between the card slot 112 and the front faceplate 108 along the determined path and in the determined fashion at element 610. At optional decision block 612, it will attempt to detect errors in the movement or changing of position. For example, if the rear faceplate 110 cannot complete a particular motion it may be an indication that something is blocking its path. A card skimmer that is attached strongly enough so that it is not detached upon striking the front faceplate 108 would potentially block the path of the rear faceplate 110 and stop its motion. Accordingly, if an error is detected when the rear faceplate 110 cannot complete its motion, flow chart 600 continues to element 614, moving the card slot 112 to a lockdown position. In this element, the rear faceplate 110 (or front faceplate 108) may be moved so that all or part of the card slot 112 is under the front faceplate 108, preventing anyone from inserting or removing electronic cards 204 from the card slot 112. This provides an additional measure of security in situations where a card skimmer is likely being used and the security of the electronic card terminal 102 has been compromised. Any final relative position for the card slot 112 and front faceplate 108 may be used. In one embodiment, a different final relative position may be used to help deter use of card skimmers attached to the front faceplate 108. The different final relative position may be determined randomly, based on the use of sensors, based on predefined algorithms, etc.

If no error is detected during the changing of the relative position (or no attempt is made to detect errors), flow chart 600 continues to element 616, receiving an electronic card 204 from the next customer. After receiving the electronic card 204, the electronic card terminal 102 may process the customer's requests or performs other actions at element 618 and eject the electronic card 204 at element 620, after which flow chart 600 either terminates or returns to element 602 for continued processing.

The method of flow chart 600, or elements thereof, may be performed at any time. In one embodiment, some or all of the elements of flow chart 600 are performed in between each customer of the electronic card terminal 102. For example, the rear faceplate 110 may be moved to attempt to knock off any card skimmers immediately after each customer completes her transaction. In another example, the rear faceplate 110 may only be moved under certain circumstances, such as usage of a predefined number of customers, a predefined amount of time, after a period or activity, etc.

It will be apparent to those skilled in the art having the benefit of this disclosure that the present invention contemplates systems and methods for preventing the use of card skimmers on electric card terminals. It is understood that the form of the invention shown and described in the detailed description and the drawings are to be taken merely as examples. It is intended that the following claims be interpreted broadly to embrace all the variations of the example embodiments disclosed.

What is claimed is:

1. An electronic card terminal comprising:
a card reader, the card reader being adapted to read information stored on an electronic card;
a rear faceplate with a card slot, the card slot being adapted to facilitate the movement of the electronic card to and from the card reader;
a front faceplate positioned to at least partially cover the rear faceplate, the front faceplate having an access hole; and
a card slot driver, the card slot driver being adapted to change the relative positions of the front faceplate and the card slot.

2. The system of claim 1, wherein the card slot driver is adapted to change the relative positions of the front faceplate and the card slot such that the card slot is completely underneath the front faceplate.

3. The system of claim 1, wherein the card slot driver is adapted to change the relative positions of the front faceplate and the card slot such that the card slot is partially underneath the front faceplate.

4. The system of claim 1, wherein the card slot driver changes the relative positions of the front faceplate and the card slot by moving the rear faceplate.

5. The system of claim 1, wherein the card slot driver changes the relative positions of the front faceplate and the card slot by moving the front faceplate.

6. The system of claim 1, wherein the card slot driver changes the relative positions of the front faceplate and the card slot by moving a portion of the front faceplate at least partially over the card slot.

7. The system of claim 1, wherein the card slot driver changes the relative positions of the front faceplate and the card slot in a vertical direction.

8. The system of claim 1, wherein the card slot driver changes the relative positions of the front faceplate and the card slot in a horizontal direction.

9. The system of claim 1, wherein the card slot driver changes the relative positions of the front faceplate and the card slot in a radial direction.

10. The system of claim 1, wherein the card slot driver changes the relative positions of the front faceplate and the card slot in a rotational direction.

11. The system of claim 1, wherein the card slot driver changes the relative positions of the front faceplate and the card slot in a random direction.

12. The system of claim 1, wherein the card slot driver is adapted to move the rear faceplate after a customer has completed a transaction on the electronic card terminal.

13. The system of claim 1, wherein the rear faceplate is located at a first position when a customer begins a transaction on the electronic card terminal, and wherein further the card slot driver is adapted to move the rear faceplate to a second different position after the customer has completed the transaction.

14. A method for preventing the use of card skimmers on an electronic card terminal, the method comprising:
ejecting from a card slot in a rear faceplate an electronic card;
determining relative movement between a front faceplate and the card slot; and
before receiving a second electronic card, changing the relative position of the card slot and the front faceplate.

15. The method of claim 14, further comprising:
detecting an error during the changing of the relative position of the card slot and the front faceplate; and
in the event an error is detected, moving the card slot to a lockdown position.

16. The method of claim 14, wherein changing the relative position of the card slot and the front faceplate comprises moving the rear faceplate.

17. The method of claim 14, wherein changing the relative position of the card slot and the front faceplate comprises moving the front faceplate.

18. The method of claim 14, wherein changing the relative position of the card slot and the front faceplate comprises changing the physical configuration of the front faceplate.

19. The method of claim 14, wherein determining the relative movement between the front faceplate and the card slot comprises randomly determining one or more movements.

20. The method of claim 14, wherein determining the relative movement between the front faceplate and the card slot comprises determining one or more horizontal movements.

21. The method of claim 14, wherein determining the relative movement between the front faceplate and the card slot comprises determining one or more vertical movements.

22. The method of claim 14, wherein determining the relative movement between the front faceplate and the card slot comprises determining one or more radial movements.

23. The method of claim 14, wherein determining the relative movement between the front faceplate and the card slot comprises determining one or more rotational movements.

24. An electronic card terminal comprising:
a rear faceplate having a card slot;
a front faceplate having an access hole;
one or more motorized rollers, the motorized rollers being adapted to pull an electronic card inserted into the card slot towards a card reader, the motorized rollers being further adapted to eject the electronic card from the card slot; and
an exit catch bin positioned between the rear faceplate and the front faceplate, the exit catch bin being adapted to catch an electronic card being ejected from the card slot.

25. The system of claim 24, wherein the motorized rollers eject the electronic card substantially vertically.

26. The system of claim 24, wherein the motorized rollers eject the electronic card towards the rear faceplate, wherein further the rear faceplate is at least partially curved.
